(19) United States
(12) Patent Application Publication
(10) Pub. No.: US 2026/0307199 A1
(43) Pub. Date: Oct. 8, 2026

(54) Method and Apparatus for Generating a Reciprocating Sanding or Polishing Path

(71) Applicant: ABB Schweiz AG, Baden (CH)

(72) Inventors: Wenyao Shao, Shanghai (CN); Wenhui Deng, Zhuhai (CN); Hao Liu, Suzhou (CN)

(21) Appl. No.: 19/697,750

(22) Filed: Jun. 4, 2026

Related U.S. Application Data
(63) Continuation of application No. PCT/CN2023/142637, filed on Dec. 28, 2023.

(51) Int. Cl. B24B 37/005; B24B 37/02; B25J 9/16; B25J 11/00

(52) U.S. Cl. CPC B24B 37/005; B24B 37/02; B25J 9/1664; B25J 11/0065

(57) ABSTRACT

A method and an apparatus for generating a reciprocating sanding or polishing path. The method includes: obtaining geometric data for a curved surface to be sanded or polished; determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface; and generating the reciprocating sanding or polishing path based on the determined parameters.

### TECHNICAL FIELD

This invention relates to a robotic technique, and more particularly, relates to a method and an apparatus for generating a sanding or polishing path.

### BACKGROUND

In the case of a robot-assisted sanding or polishing process, a sanding or polishing path is typically generated automatically based on the obtained geometric information of a surface of a work piece to be sanded or polished.

However, with respect to some curved surfaces with varying curvatures, e.g., a round corner, it is generally difficult to achieve high-precision sanding or polishing results. In the existing methods, in order to obtain a suitable sanding or polishing path, a plurality of possible paths might have to be tested and further the optimal sanding or polishing path is generally selected based on the sanding experience of a skilled artisan.

### SUMMARY

The invention is defined by the claims.

According to a first aspect of the disclosure, there is provided a method for generating a reciprocating sanding or polishing path. The method comprises: obtaining geometric data for a curved surface to be sanded or polished; determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface; and generating the reciprocating sanding or polishing path based on the determined parameters.

In some embodiments, the determining path parameters for a reciprocating sanding or polishing path having a plurality of back-and-forth path cycles to be used for the curved surface based on the geometric data may comprise: decreasing the spacing value with the increase of the curvature of the curved surface; and increasing the spacing value with the decrease of the curvature of the curved surface.

In some embodiments, the determining path parameters for a reciprocating sanding or polishing path having a plurality of back-and-forth path cycles to be used for the curved surface based on the geometric data may comprise: determining the spacing value based on the curvature of the curved surface and a deformed amount of a sanding tool to be pressed against the curved surface under a predetermined pressure.

In some embodiments, each back-and-forth path cycle is composed of linear and/or curved paths.

In some embodiments, the back-and-forth path cycle has a linear forward path along a forward direction and a linear backward path along a backward direction; and the reciprocating sanding or polishing path has a main sanding or polishing direction substantially perpendicular to the forward direction and the backward direction.

In some embodiments, the curved surface to be sanded or polished may be a corner surface of a work piece.

In some embodiments, the determining path parameters for a reciprocating sanding or polishing path having a plurality of back-and-forth path cycles to be used for the curved surface based on the geometric data may comprise: dividing the curved surface into a plurality of portions each having a substantially constant curvature; and determining a respective spacing value for a respective portion of the curved surface based on the respective curvature of the respective portion.

In some embodiments, the generating the reciprocating sanding or polishing path based on the determined parameters may comprise: generating a reciprocating sanding or polishing path for each portion of the curved surface based on the determined respective spacing value.

In some embodiments, the determining path parameters for a reciprocating sanding or polishing path having a plurality of back-and-forth path cycles to be used for the curved surface based on the geometric data may comprise: selecting, by a user, a desired portion of the curved surface; and determining, by the user, a number of the back-and-forth path cycles for the desired portion as one of the path parameters, the number of the back-and-forth path cycles being selected as being different from those for the adjacent portions of the curved surface.

In some embodiments, the generating the reciprocating sanding or polishing path based on the determined parameters may comprise: generating a reciprocating sanding or polishing path for the desired portion based on the determined number of the back-and-forth path cycles.

In some embodiments, the generating the reciprocating sanding or polishing path based on the determined parameters may comprise: for the reciprocating sanding or polishing path being a zigzag path, selecting a plurality of first side points and a plurality of second side points for the plurality of back-and-forth path cycles based on the determined parameters; connecting each first side point to its nearby second side points in a linear or arc form to form a plurality of linear or arc back-and-forth path cycles; and projecting the plurality of linear or arc back-and-forth path cycles onto the curved surface to form the reciprocating sanding or polishing path.

According to a second aspect of the disclosure, there is provided an apparatus for generating a reciprocating sanding or polishing path. The apparatus may comprise: a processor configured to implement the method for generating a reciprocating sanding or polishing path as stated above.

According to a third aspect of the disclosure, there is provided a robot. The robot may comprise: a processor configured to implement the method for generating a reciprocating sanding or polishing path as stated above; and an end effector coupled to the controller and configured to enable a sanding tool held thereon to sand or polish the curved surface in accordance with the generated reciprocating sanding or polishing path.

According to a fourth aspect of the disclosure, there is provided a computer readable medium having a computer program stored thereon which, when executed by a processor, implements the method as stated above.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIG. 1A illustrates a typical sanding or polishing scenario for a planar surface of a work piece;

FIGS. 1B-1E illustrate several typical reciprocating sanding or polishing paths that are used for sanding or polishing a surface, respectively;

FIGS. 2A-2C illustrate several different schematic scenarios for a sanding tool contacting a curved surface with a different curvature;

FIG. 3 illustrates a flowchart of a method for generating a reciprocating sanding or polishing path according to one embodiment of the present disclosure;

FIG. 4A illustrates a typical type of zigzag path with a triangular wave pattern;

FIG. 4B illustrates another typical type of zigzag path with a square wave pattern;

FIG. 5 illustrates an example for measuring the contact area between a sanding tool and the curved surface under a predetermined pressure; and

FIGS. 6A and 6B illustrate an example of how to connect each first side point to its nearby second side point(s) in a linear form and how to generate a reciprocating sanding or polishing path by projecting a plurality of linear back-and-forth path cycles onto a curved surface, respectively.

### DETAILED DESCRIPTION

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one embodiment.” The following text also can comprise other explicit and implicit definitions.

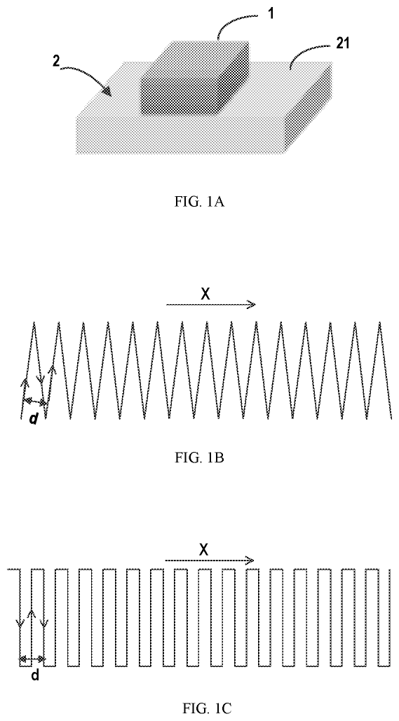

FIG. 1A illustrates a typical sanding or polishing scenario for a planar surface of a work piece.

As illustrated in FIG. 1A, a sanding tool 1 may be pressed against a planar surface 21 of a work piece 2 under a predetermined pressure. Typically, the sanding tool 1 may be a sanding paper with a predetermined thickness. In some embodiments, the sanding tool 1 may be held by or mounted on an end effector of a robot (not shown) and configured to be controlled to move along a planned sanding or polishing path.

Just as an example, the robot may be an industrial robot having multiple arms with multiple degrees of freedom, e.g., a two-arm robot with 6 degrees of freedom. In some embodiments, a controller or processor may be associated or integrated with the robot, such that the end effector as well as the sanding tool 1 held or mounted thereon may be guided to a desired position or moved along a planned sanding or polishing path.

Just as examples, FIGS. 1B-1E illustrate several typical reciprocating sanding or polishing paths that are used for sanding or polishing a surface, respectively. Those skilled in the art would appreciate that other types of the reciprocating sanding or polishing paths are also possible.

As shown in FIGS. 1B and 1C, the reciprocating sanding or polishing path may be a zigzag path, wherein the zigzag path in FIG. 1B is characterized by a plurality of back-and-forth path cycles with a triangular wave pattern, while the zigzag path in FIG. 1C is characterized by a plurality of back-and-forth path cycles with a square wave pattern.

As shown in FIGS. 1E and 1D, the reciprocating sanding or polishing path may be a loop-like path, wherein the loop-like path in FIG. 1E is characterized by a plurality of back-and-forth path cycles with a diamond-like pattern, while the loop-like path in FIG. 1E is characterized by a plurality of back-and-forth path cycles with a ring-like pattern.

For any of the above typical reciprocating sanding or polishing paths, there is a spacing d between any two adjacent back-and-forth path cycles. Typically, in the existing methods, the spacing value d between any two adjacent back-and-forth path cycles is kept constant for the whole surface to be sanded or grinded.

However, it is found that a problem might arise if a reciprocating sanding or polishing path having a constant spacing value is applied to a curved surface with a varied curvature.

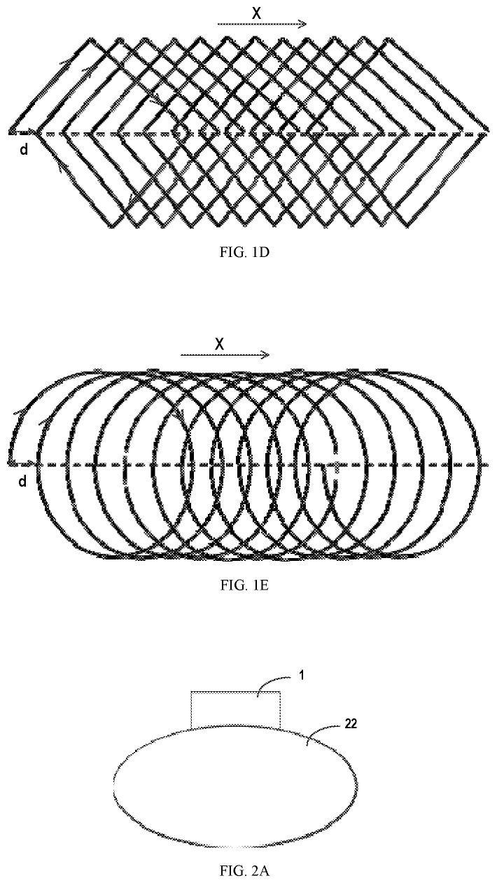

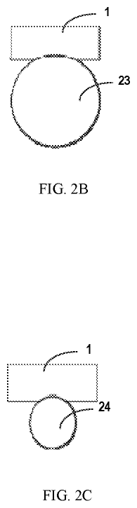

For better understanding of this problem, FIGS. 2A-2C illustrate several different schematic scenarios for a sanding tool contacting a curved surface with a different curvature.

Specifically, FIG. 2A illustrates a sanding surface of a sanding tool 1 being in full contact with a curved surface 22 having a first curvature; FIG. 2B illustrates a sanding surface of a sanding tool 1 being in part contact with another curved surface 23 having a second curvature; and FIG. 2C illustrates a sanding surface of a sanding tool 1 being in part contact with yet another curved surface 24 having a third curvature, wherein the first curvature is smaller than the second curvature, and the second curvature is smaller than the third curvature.

As can be seen from FIGS. 2A-2C, unlike the planar surface 21 in FIG. 1A, in the case of a curved surface having a varied curvature, the contact area between the sanding tool 1 and the curved surface would vary with the curvature. Due to this fact, the inventor has found that a constant spacing value between any two adjacent back-and-forth path cycles might lead to an insufficient coverage for the curved surface to be sanded or polished and then a non-uniform sanding or polishing result. Typically, such a curved surface with a varied curvature may be a curved surface of a round corner.

In order to overcome the above problem, the present disclosure provides an improved method for generating a reciprocating sanding or polishing path. The method comprises: obtaining geometric data for a curved surface to be sanded or polished; determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface; and generating the reciprocating sanding or polishing path based on the determined parameters. With the above improved method provided, those skilled in the art would appreciate that: not only the sanding or polishing path for a curved surface with a varied curvature can be easily generated, but also a more uniform grinding or polishing result can be realized.

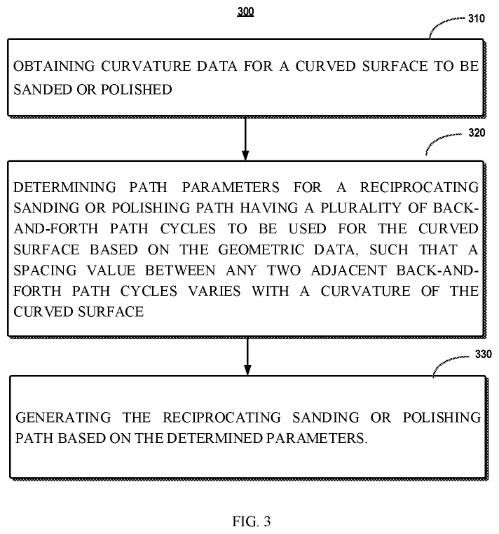

For better understanding of the concept of the present method, FIG. 3 illustrates a flowchart of a method for generating a reciprocating sanding or polishing path according to one embodiment of the present disclosure. Those skilled in the art would appreciate that the method may be implemented by a processor, a controller or any other computing device, which may be associated or integrated with a robot holding the sanding tool for implementing the sanding or polishing process.

The method 300 may start at block 310, i.e., obtaining geometric data for a curved surface to be sanded or polished.

Generally, the curved surface may be any curved surface of a work piece to be sanded or polished. In some embodiments, the geometric data may comprise: coordinates of the curved surface, a shape of the curved surface, a curvature of any point on the curved surface, and/or an average curvature for a specific portion of the curved surface, etc.

In some embodiments, the geometric data may be measured by a measuring device. Typically, the measuring device may be realized by a camera for capturing the image of the curved surface in combination with a computing device (e.g., a processor) for processing the captured image. In some embodiments, a 3D model for the curved surface may be firstly established and then the geometric data may be obtained based on the established model.

Once the geometric data for the curved surface is obtained, the method may proceed to block 320, i.e., determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface.

It is known in the art that a reciprocating sanding or polishing path would be useful for sanding or polishing a surface, especially, a curved surface. It is then important to know the path parameters of the reciprocating sanding or polishing path.

Typically, the reciprocating sanding or polishing path has a plurality of back-and-forth path cycles and the back-and-forth path cycle may be defined by a forward path and a backward path. Typically, the back-and-forth path cycle may be of any back-and-forth pattern having at least a forward path and a backward path. In some embodiments, each back-and-forth path cycle may be composed of any kind of linear and/or curved paths.

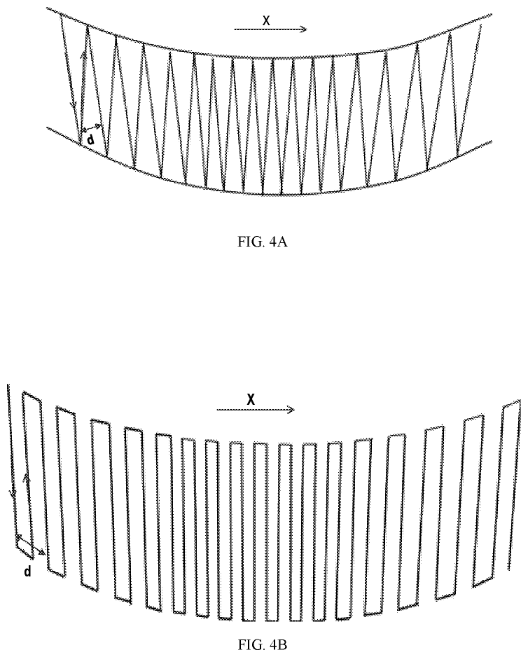

Further, in order to sand or polish the curved surface while the sanding tool is moving on the surface, the reciprocating sanding or polishing path generally has a main sanding or polishing direction (designated as X in FIGS. 4A and 4B). In some embodiments, the main sanding or polishing direction may be substantially perpendicular to a forward direction of a forward path and a backward direction of a backward path within a back-and-forth path cycle.

Just as an example, the reciprocating sanding or polishing path may be a zigzag path. FIG. 4A illustrates a typical type of zigzag path with a triangular wave pattern, while FIG. 4B illustrates another typical type of zigzag path with a square wave pattern. Those skilled in the art would appreciate that the above zigzag paths in FIGS. 4A and 4B are just examples, in some embodiments, other types of reciprocating sanding or polishing path are also possible.

The path parameters may comprise various path parameters including but not limited to e.g., a specific path pattern for the reciprocating sanding or polishing path, a start point and an end point of the reciprocating sanding or polishing path, a number of the back-and-forth path cycles, a length of a forward path and a backward path for each back-and-forth path cycle, and/or a spacing value d between any two adjacent back-and-forth path cycles, etc.

The spacing value between two adjacent back-and-forth path cycles may be one of the most interesting path parameters in the present disclosure. In some embodiments, the spacing value d may be defined as a shortest distance between two corresponding points on two adjacent back-and-forth path cycles. Of course, the spacing value may be otherwise defined.

It is found that adjusting the spacing value with the change of the curvature of the curved surface may improve the sanding or polishing effects for the curved surface, especially, e.g., a round corner surface.

Therefore, in some embodiments the determining path parameters for a reciprocating sanding or polishing path having a plurality of back-and-forth path cycles to be used for the curved surface based on the geometric data may comprise: decreasing the spacing value with the increase of the curvature of the curved surface; and increasing the spacing value with the decrease of the curvature of the curved surface. Typically, the spacing value may be increased or decreased smoothly or gradually with the change of the curvature of the curved surface. Typically, the decreasing or increasing step may be performed automatically in response to the obtained curvature data for the curved surface. In this way, those skilled in the art would appreciate that the reciprocating sanding or polishing path with a varied or adjustable spacing may be better suited to the curved surface.

In some embodiments, the determining path parameters for a reciprocating sanding or polishing path having a plurality of back-and-forth path cycles to be used for the curved surface based on the geometric data may comprise: determining the spacing value based on the curvature of the curved surface and a deformed amount of a sanding tool (e.g., a sand paper) to be pressed against the curved surface under a predetermined pressure.

It is known in the art that the contact area between a sanding tool (e.g., a sand paper) and the curved surface under a predetermined pressure is not only affected by the curvature of the curved surface, but also by a deformed amount of a sanding tool. Generally, the spacing value may be related to the contact area. Therefore, in some cases the spacing value may be determined or estimated based on the curvature of the curved surface and the deformed amount of the sanding tool.

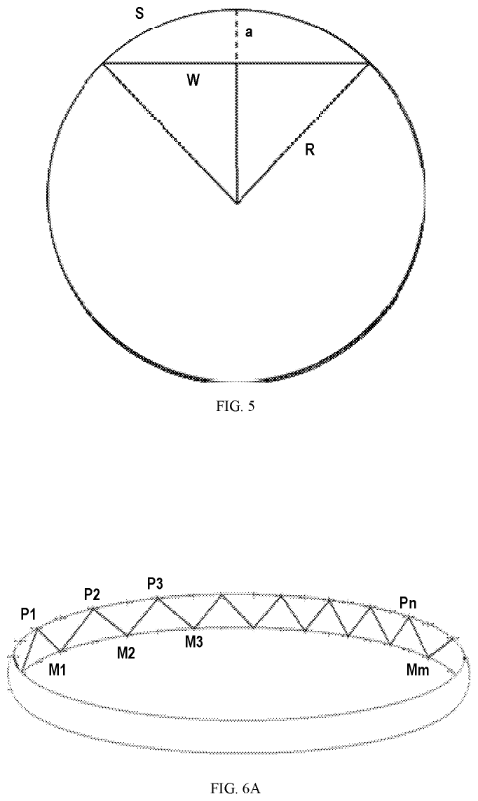

Just as an example, FIG. 5 illustrates an example for measuring the contact area between a sanding tool (e.g., a sand paper) and the curved surface under a predetermined pressure.

As shown in FIG. 5, assuming that S is a curved surface to be sanded or polished; chord W may represent a contact area between a sanding tool (e.g., a sand paper) and the curved surface; a is a deformed amount of the sanding tool when pressed against the curved surface under a predetermined pressure; and R is a radius of curvature for the curved surface S, then W may be formulated as below.

W=2*\sqrt{2Ra−a²} (1)

Those skilled in the art would appreciate that the contact area may then be represented by W and thereafter the spacing value may be determined or estimated based on said W. Typically, the spacing value may be determined to be smaller or equal to W, so as to realize a full coverage of the curved surface. Those skilled in art would further appreciate that in some other embodiments, other ways for determining the spacing value are also possible.

In some embodiments, the determining path parameters for a reciprocating sanding or polishing path having a plurality of back-and-forth path cycles to be used for the curved surface based on the geometric data may be performed with respect to separate portions of the curved surface. In this case, the determining path parameters for a reciprocating sanding or polishing path having a plurality of back-and-forth path cycles to be used for the curved surface based on the geometric data may then comprise: dividing the curved surface into a plurality of portions each having a substantially constant curvature; and then determining a respective spacing value for a respective portion of the curved surface based on the respective curvature of the respective portion.

Those skilled in the art would appreciate that in the above embodiments the steps of dividing the curved surface into a plurality of portions and then determining a respective spacing value for a respective portion may be performed automatically. However, this is not a limitation, in some embodiments the spacing value may also be indirectly determined by a user, e.g., through selecting a number of the back-and-forth path cycles for a desired portion, as will be described thereafter.

To be more specific, in some embodiments, the determining path parameters for a reciprocating sanding or polishing path having a plurality of back-and-forth path cycles to be used for the curved surface based on the geometric data may comprise: selecting, by a user, a desired portion of the curved surface; and determining, by the user, a number of the back-and-forth path cycles for the desired portion as the path parameter, the number of the back-and-forth path cycles may be different from those for the adjacent portions of the curved surface.

Just as an example, for a round corner surface comprising a center portion and two side portions adjacent the center portion, a user may firstly select the two side portions as a desired portion, and since the two side portions each have a smaller curvature, then the user may determine using a small number of back-and-forth path cycles (e.g. five) for the two side portions. Next, the user may select the center portion as a desired portion, and since the center portion has a larger curvature, then the user may determine using a large number of back-and-forth path cycles (e.g. nine) for the center portion. In other words, the number of back-and-forth path cycles for a portion of a curved surface may be selected as desired based on the curvature of the portion.

In general, the number of back-and-forth path cycles for different portions of a curved surface should be selected such that the spacing value for the curved surface may vary with the curvature of the curved surface. Typically, the number of back-and-forth path cycles for different portions of a curved surface may be selected such that the spacing value for the curved surface may smoothly or gradually vary with the curvature of the curved surface.

With the above method, those skilled in the art would appreciate that the spacing value may then be indirectly altered by altering the number of back-and-forth path cycles. Those skilled in the art would further appreciate that the method for altering the number of the back-and-forth path cycles could also be easily implemented by a user, thereby reducing the complexity of actual application.

In addition to the above spacing value, other path parameters including a specific path pattern for the reciprocating sanding or polishing path, a specific region on the curved surface for the reciprocating sanding or polishing path, a start point or an end point of the reciprocating sanding or polishing path, a number of the back-and-forth path cycle, a length of a forward path and a backward path for each back-and-forth path cycle, etc. may also be determined in block 320.

Once the various path parameters are determined, the method may proceed to block 330, i.e., generating the reciprocating sanding or polishing path based on the determined parameters.

Specifically, in the embodiments in which the curved surface is divided into a plurality of portions each having a substantially constant curvature, the generating the reciprocating sanding or polishing path based on the determined parameters may comprise: generating a reciprocating sanding or polishing path for each portion of the curved surface based on the determined respective spacing value.

In the embodiments in which a number of the back-and-forth path cycles for the desired portion is determined as the path parameter by the user, the generating the reciprocating sanding or polishing path based on the determined parameters may comprise: generating a reciprocating sanding or polishing path for the first portion based on the selected number of the back-and-forth path cycles.

In some embodiments with the reciprocating sanding or polishing path being a zigzag path, the generating the reciprocating sanding or polishing path based on the determined parameters may comprise: selecting a plurality of first side points and a plurality of second side points for the plurality of back-and-forth path cycles based on the determined parameters (e.g., the spacing number and/or the number of the back-and-forth path cycles); connecting each first side point to its nearby second side point(s) in a linear or arc form to form a plurality of linear or arc back-and-forth path cycles; and projecting the plurality of linear or arc back-and-forth path cycles onto the curved surface to form the reciprocating sanding or polishing path. It will be understood that in the case that the first side points are connected to its nearby second side point(s) in an arc form, the resulted reciprocating sanding or polishing path on the surface may be more smooth.

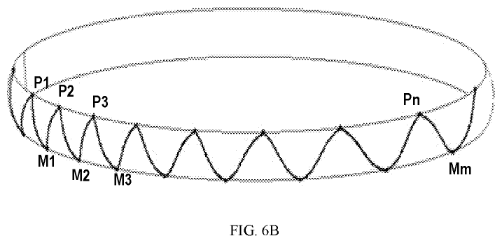

Just as an example, FIGS. 6A and 6B illustrate an example of how to connect each first side point to its nearby second side point(s) in a linear form and how to generate a reciprocating sanding or polishing path by projecting a plurality of linear back-and-forth path cycles onto a curved surface, respectively.

As shown in FIG. 6A, a plurality of first side points P1, P2, P3, . . . , Pn and a plurality of second side points M1, M2, M3, . . . , Mm may be selected for a plurality of back-and-forth path cycles based on the spacing value and/or the number of the back-and-forth path cycles as determined above, wherein m and n are both an integer number. In addition, m may be larger than, equal to or less than n.

Next, each first side point i.e., P1, P2, P3, . . . , Pn, may be linearly connected to its nearby second side points, i.e., M1, M2, M3, . . . , Mm to form a plurality of linear back-and-forth path cycles. Those skilled in the art would appreciate that in this way, a plurality of linear back-and-forth path cycles might not conform to the curvature of the curved surface.

In order for conforming the plurality of linear back-and-forth path cycles to the curvature of the curved path, the plurality of linear back-and-forth path cycles would then be projected onto the curved surface to form a reciprocating sanding or polishing path. FIG. 6B illustrates a result of the plurality of linear back-and-forth path cycles being projected onto the curved surface.

Through the above description, it should be understood that the connecting each first side point to its nearby second side point(s) in an arc form is also possible. Just as an example, to facilitate said connecting in such an arc form, one middle point may be determined based on each first side point and its nearby second side point, then an arc path may be formed by drawing an arc line connecting each first side point, the respective middle point and its nearby second side point. In this way, a plurality of arc back-and-forth path cycles may be created, and thereafter the plurality of linear or arc back-and-forth path cycles may be projected onto the curved surface to generate the reciprocating sanding or polishing path.

Various embodiments have been described with respect to the method for generating a reciprocating sanding or polishing path. Those skilled in the art would appreciate that a reciprocating sanding or polishing path can be easily and fast generated, which is particularly suitable for a curved surface especially with a varied curvature, e.g., a corner surface. Also, a high-precision sanding or polishing result can be achieved. As compared to the existing methods, the time for generating the sanding or polishing path may be reduced. Also, the complexity for generating the sanding or polishing path is reduced.

Those skilled in the art would further appreciate that the present disclosure may also relates to an apparatus for generating a sanding or polishing path, the apparatus may comprise: a processor configured to implement the method for generating a sanding or polishing path as stated above. Such an apparatus may for example be any computing device. Also, the present disclosure may relate to a robot comprising: a processor configured to implement the method for generating a sanding or polishing path as stated above; and an end effector coupled to the controller and configured to enable a sanding tool held thereon to sand or polish the curved surface in accordance with the generated sanding or polishing path.

Further, the present disclosure may also relate to a computer readable medium having a computer program stored thereon which, when executed by a processor, implements the method as stated above.

Although the above method is described with steps in sequence, it is noted that the sequence of the steps in the method may be changed, reordered, combined, omitted, modified, etc., as appropriate. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for generating a reciprocating sanding or polishing path, comprising:
obtaining geometric data for a curved surface to be sanded or polished;
determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface; and
generating the reciprocating sanding or polishing path based on the determined parameters.

2. The method of claim 1, wherein the determining path parameters for a reciprocating sanding or polishing path having a plurality of back-and-forth path cycles to be used for the curved surface based on the geometric data comprises:
decreasing the spacing value with the increase of the curvature of the curved surface; and
increasing the spacing value with the decrease of the curvature of the curved surface.

3. The method of claim 1, wherein the determining path parameters for a reciprocating sanding or polishing path having a plurality of back-and-forth path cycles to be used for the curved surface based on the geometric data comprises:
determining the spacing value based on the curvature of the curved surface and a deformed amount of a sanding tool to be pressed against the curved surface under a predetermined pressure.

4. The method of claim 1, wherein each back-and-forth path cycle is composed of linear and/or curved paths.

5. The method of claim 1, wherein the back-and-forth path cycle has a linear forward path along a forward direction and a linear backward path along a backward direction; and
wherein the reciprocating sanding or polishing path has a main sanding or polishing direction substantially perpendicular to the forward direction and the backward direction.

6. The method of claim 1, wherein the curved surface to be sanded or polished is a corner surface of a work piece.

7. The method of claim 1, wherein the determining path parameters for a reciprocating sanding or polishing path having a plurality of back-and-forth path cycles to be used for the curved surface based on the geometric data comprises:
dividing the curved surface into a plurality of portions each having a substantially constant curvature; and
determining a respective spacing value for a respective portion of the curved surface based on the respective curvature of the respective portion.

8. The method of claim 7, wherein the generating the reciprocating sanding or polishing path based on the determined parameters comprises:
generating a reciprocating sanding or polishing path for each portion of the curved surface based on the determined respective spacing value.

9. The method of claim 1, wherein the determining path parameters for a reciprocating sanding or polishing path having a plurality of back-and-forth path cycles to be used for the curved surface based on the geometric data comprises:
selecting, by a user, a desired portion of the curved surface; and
determining, by the user, a number of the back-and-forth path cycles for the desired portion as one of the path parameters, the number of the back-and-forth path cycles being selected as being different from those for the adjacent portions of the curved surface.

10. The method of claim 9, wherein the generating the reciprocating sanding or polishing path based on the determined parameters comprises:
generating a reciprocating sanding or polishing path for the desired portion based on the determined number of the back-and-forth path cycles.

11. The method of claim 1, wherein the generating the reciprocating sanding or polishing path based on the determined parameters comprises: for the reciprocating sanding or polishing path being a zigzag path,
selecting a plurality of first side points and a plurality of second side points for the plurality of back-and-forth path cycles based on the determined parameters;
connecting each first side point to its nearby second side points in a linear or arc form to form a plurality of linear or arc back-and-forth path cycles; and
projecting the plurality of linear or arc back-and-forth path cycles onto the curved surface to form the reciprocating sanding or polishing path.

12. An apparatus for generating a reciprocating sanding or polishing path comprising:
a processor configured to implement a method for generating a reciprocating sanding or polishing path and obtaining geometric data for a curved surface to be sanded or polished, the steps including;
determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface; and
generating the reciprocating sanding or polishing path based on the determined parameters.

13. A robot comprising:
a processor configured to implement a method for generating a reciprocating sanding or polishing path and obtaining geometric data for a curved surface to be sanded or polished, the steps including;
determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface; and
generating the reciprocating sanding or polishing path based on the determined parameters; and
an end effector coupled to the controller and configured to enable a sanding tool held thereon to sand or polish the curved surface in accordance with the generated reciprocating sanding or polishing path.

14. A computer readable medium having a computer program stored thereon which, when executed by a processor, implements a method of obtaining geometric data for a curved surface to be sanded or polished, the steps including;
determining path parameters for a reciprocating sanding or polishing path having a plurality of back-and-forth path cycles to be used for the curved surface based on the geometric data, such that a spacing value between any two adjacent back-and-forth path cycles varies with a curvature of the curved surface; and
generating the reciprocating sanding or polishing path based on the determined parameters.

15. The method of claim 2, wherein the determining path parameters for a reciprocating sanding or polishing path having a plurality of back-and-forth path cycles to be used for the curved surface based on the geometric data comprises:
determining the spacing value based on the curvature of the curved surface and a deformed amount of a sanding tool to be pressed against the curved surface under a predetermined pressure.

16. The method of claim 2, wherein each back-and-forth path cycle is composed of linear and/or curved paths.

17. The method of claim 2, wherein the back-and-forth path cycle has a linear forward path along a forward direction and a linear backward path along a backward direction; and
wherein the reciprocating sanding or polishing path has a main sanding or polishing direction substantially perpendicular to the forward direction and the backward direction.

18. The method of claim 2, wherein the curved surface to be sanded or polished is a corner surface of a work piece.

19. The method of claim 2, wherein the determining path parameters for a reciprocating sanding or polishing path having a plurality of back-and-forth path cycles to be used for the curved surface based on the geometric data comprises:
dividing the curved surface into a plurality of portions each having a substantially constant curvature; and
determining a respective spacing value for a respective portion of the curved surface based on the respective curvature of the respective portion.
